(19) United States
(12) Patent Application Publication
(10) Pub. No.: US 2017/0032337 A1
(43) Pub. Date: Feb. 2, 2017

(54) PAIRING OF TRANSACTIONAL PARTNERS USING ASSOCIATED DATA AND IDENTIFIERS

(71) Applicant: PAYPAL, INC., San Jose, CA (US)

(72) Inventor: Alexander Berger, Sammamish, WA (US)

(21) Appl. No.: 14/810,390

(22) Filed: Jul. 27, 2015

(51) Int. Cl. G06Q 20/10; H04L 29/08; G06Q 20/32

(52) U.S. Cl. CPC G06Q 20/102; G06Q 20/325; H04L 67/22; H04L 67/20

(57) ABSTRACT

There are provided systems and methods for pairing of transaction partners using associated data and identifiers. A user may engage in a transaction with a merchant, where the merchant may generate an invoice for the transaction using a merchant device. The user may wish to provide payment for the invoice using a payment provider, for example, through a mobile payment application of a communication device in possession of the user. The merchant may request that the invoice be matched to the user based on similar parameters or other information for the merchant and the user. The similar parameters may correspond to a shared location or other shared data. If the invoice is matched to the user, the invoice may be published to the payment application of the communication device. The user may then view the invoice and provide payment using the payment application.

### TECHNICAL FIELD

The present application generally relates to matching of entities in a digital transaction through associated data and more specifically to pairing of transaction partners using associated data and identifiers.

### BACKGROUND

Users and merchants may engage in digital transactions associated with real world purchases. For example, a user may purchase a product at a brick and mortar store through a mobile payment application of a mobile smart phone. At other times, the user may pay for a service offered or provided by a merchant, such as a taxi trip, using digital payments through their mobile smart phone. In these instances, the merchant and user may know they are interacting, and may establish a transaction by the user navigating the merchant's website or other sales interface and allowing the user to approve and pay for the transaction. However, these interactions may require multiple entries by the user to identify the merchant in order to receive and process the transaction. Where the user and merchant have not previous identified each other and generated the transaction by communicating information back and forth, it can be laborious for the user or the merchant to enter each other's identifiers into their respective payment or sales applications in order to approve the transaction and provide payment for the transaction. Additionally, errors in entry of the identifiers, especially with mobile devices having smaller displays and keypads, may cause improper payments to other parties. Moreover, the user may be dissuaded from utilizing the payment application to provide payment when the user is in a rush and requires immediate payment.

### BRIEF DESCRIPTION OF THE DRAWINGS

FIG. 1 is a block diagram of a networked system suitable for implementing the processes described herein, according to an embodiment;

FIG. 2 is an exemplary environment having users and merchants engaged in transactions, where the users may be matched to a pending transaction based on associated data between the user and the merchant, according to an embodiment;

FIG. 3 is an exemplary interaction between a communication device, a payment provider server, and a merchant device for pairing of transactions based on associated data between a user and a merchant, according to an embodiment;

FIG. 4 is a flowchart of an exemplary process for pairing of transaction partners using associated data and identifiers, according to an embodiment; and

FIG. 5 is a block diagram of a computer system suitable for implementing one or more components in FIG. 1, according to an embodiment.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

Provided are methods utilized for pairing of transaction partners using associated data and identifiers. Systems suitable for practicing methods of the present disclosure are also provided.

A user may wish to provide a payment to a merchant for a transaction between the user and the merchant (or more generally between a payer and a payee). The transaction may be for past products, goods, and/or services (referred to herein as an “item” or “items”) that the merchant has provided to the user, or may be for an item or items that the user wishes to obtain. For example, the user may wish to provide payment for a taxi ride or a meal consumed at a restaurant. At other times, the user may be at a merchant location and wish to provide payment to obtain the item, such as food at a grocery store or electronics at a retail storefront. In order to provide payment, the user and/or merchant may wish to utilize a payment provider, which may provide a payment to the merchant for the transaction using a payment instrument of the user. The payment instrument may correspond to a payment account for the user with the payment provider, which may send and receive funds between one or more other accounts and/or financial institutions. In other embodiments, the payment instrument may correspond to stored financial instruments for the user, such as checking/savings account information, debit/credit cards, gift balances (e.g., gift cards associated with a merchant), benefits and discounts, and/or other types of funding available to the user. The merchant may further have a payment account with the payment provider as well in order to receive the payment from the user. However, in other embodiments, the merchant may have another financial account with another financial institution, where the payment provider may provide the payment to the merchant's financial institution for processing.

Thus, the user may engage in a transaction with the merchant for one or more items that the user wishes to purchase using the payment provider to provide payment. The merchant may cause a digital invoice to be generated for the transaction. The digital invoice may include the item(s) the user wishes to purchase/provide payment for, as well as a cost or price for the items including any associated costs, in certain embodiments, such as tax, tip, etc. However, in other embodiments, the user may later add a tip amount to the transaction, and thus, the user may later change the cost or price for the transaction. In such embodiments, the digital invoice may remain open for editing by the user. The merchant may utilize a sales application of a communication device to generate the digital invoice. Once the digital invoice has been generated, the merchant may request that the user be added or matched to the digital invoice. In this regard, in order to provide the payment to the merchant, the user may be required to be matched or associated with the digital invoice for the transaction. The merchant may request that the sales application perform the matching, or may communicate/publish the digital invoice to the payment provider so that the payment provider performs the matching of the user to the digital invoice.

In order to match the user to the digital invoice so that the user may view the digital invoice, accept/decline payment for the digital invoice, and/or edit the digital invoice, merchant data for the merchant may be required. The merchant data may include one or more parameters for the merchant, which may be processed to determine information about the merchant. For example, the merchant parameters may be associated with location data for a current location of the merchant and/or a merchant storefront, identifiers used to identify the merchant, past merchant transactions by the merchant with the user, past interactions between the user and the merchant, a merchant category for the merchant, and/or an item category for items sold by the merchant. In other embodiments, transaction data may be used, which may include similar information to the merchant data. For example, the transaction data may include items in the transaction, a location for the transaction, a name or other identifier for the transaction, and/or a cost associated with the transaction. The aforementioned information may be communicated to the payment provider with the digital invoice or entered to the merchant device. In other embodiments, the information may be stored by the payment provider/merchant device prior to engaging in the transaction.

Additionally, user information for a plurality of users that utilize the payment provider and/or a mobile payment application provided by the payment provider (e.g., for use with a communication device, such as a mobile smart phone) may be accessed. The user information may be processed to determine one or more most closely matched users to the merchant based on a correlation or match between the merchant data and the user information. Thus, the user information may have user parameters for each of the users in the user data. The user parameters may be associated with a location for the user, past user transactions by the user, the interactions between the user and the merchant, a user image for the user, image of an object or item associated with the user, and an identifier of the object or the item associated with the user. The user parameter may also correspond to user voice data, where the voice data may correspond to voice data input stored by a payment provider server. In this regard, when a user parameter for a location of the user matches a merchant parameter/transaction parameter for a location of the merchant/transaction, the user may be matched to the digital invoice based on similar locations for the user and merchant engaging in the transaction. In other embodiments, other matches/correlations may be used. For example, the merchant may capture an image of the user or a license plate of a car for the user (e.g., at a gas station), and may link the user to a specific transaction at that location based on a stored image of the user or stored license plate number for the user, respectively.

However, where more than one user matches or is correlated with the merchant parameters based on their respective user parameters, additional information may be used to determine the correct user to match to the digital invoice for the transaction. For example, the user may provide the merchant with a name for the user, so that the merchant may select the correct user when viewing a list of matching/correlated users. Other information may also be provided to the merchant (e.g., an account name, code identifying the account, account image, phone number or subset of phone number, etc.). In other embodiments, the merchant may view an image or other account information for the user when viewing a list of the matching/correlated users, and may select the user most closely matching the viewed information. In other embodiments, the merchant may publish the digital invoice to the subset of users with matching/correlated data so that each user may view the digital invoice. The correct user may then utilize their payment application to select the digital invoice and provide payment for the digital invoice.

The user may also be matched to the digital invoice based on strength of the correlation/match between the user parameters and the merchant parameters. For example, if the user and the merchant have past transaction, the user may be more likely to be engaged in a transaction with the merchant. Additionally, past location information may also be used to determine that the user is engaged in the transaction with the merchant. For example, during a taxi ride, the user and the merchant may co-located for a period of time. Thus, the user and the merchant are likely to be engaged in the transaction for payment of that taxi ride. In other embodiments, if the user has previously visited the merchant and/or previously purchased similar items, it may be likely that the user and the merchant are again engaged in that transaction.

The user's communication device may then pick up or receive the published/transmitted digital invoice from the merchant after the digital invoice is matched to the user. In various embodiments, the digital invoice may be included with or in a message from the merchant and/or payment provider, which may include a communication from the merchant/payment provider or other information. Once the user's communication device picks up the published digital invoice, the user may view the digital invoice through a mobile payment application or other application of the communication device. The user may then accept or decline the transaction. For example, if the transaction is for the wrong user, the user may decline the transaction and another matching user may be determined. In other embodiments, the user may request a change to the transaction, which the user may make to the digital invoice or may decline the digital invoice and request a new invoice be created and published to the user by the merchant. However, if the user accepts the digital invoice, the user may communicate a payment request for the transaction in the digital invoice to the payment provider. The payment provider may then engage in transaction processing, for example, by providing a payment to the merchant for the transaction. The user may also alter the payment total for the payment request, such as by adding a tip to the payment total or reducing a previously requested gratuity amount.

Thus, a payee may simply send a request for payment (such as in the form of a digital invoice) without having to know or enter a payer's phone number or other identifier, and the payer does not need to provide any identifying information to the payee. Location information between the payee and payer is used to determine one or more likely recipients of the payee's request (i.e., payers). Once the desired payer is identified, payment can be processed without having payer (or payee) information exposed and/or entered by either party to the transaction.

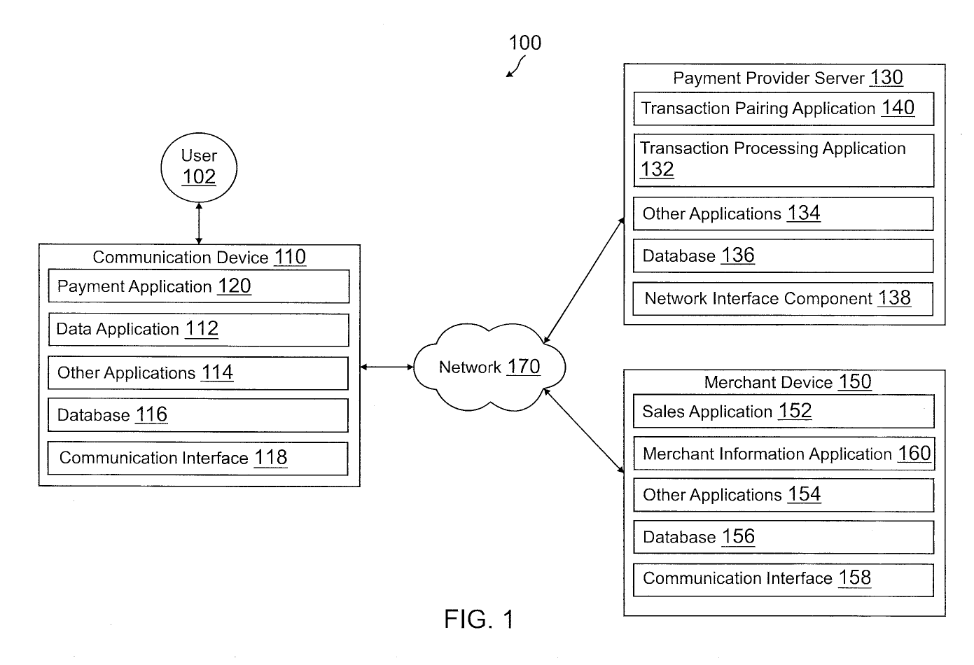

FIG. 1 is a block diagram of a networked system 100 suitable for implementing the processes described herein, according to an embodiment. As shown, system 100 may comprise or implement a plurality of devices, servers, and/or software components that operate to perform various methodologies in accordance with the described embodiments. Exemplary devices and servers may include device, stand-alone, and enterprise-class servers, operating an OS such as a MICROSOFT® OS, a UNIX® OS, a LINUX® OS, or other suitable device and/or server based OS. It can be appreciated that the devices and/or servers illustrated in FIG. 1 may be deployed in other ways and that the operations performed and/or the services provided by such devices and/or servers may be combined or separated for a given embodiment and may be performed by a greater number or fewer number of devices and/or servers. One or more devices and/or servers may be operated and/or maintained by the same or different entities.

System 100 includes a user 102, a communication device 110, a payment provider server 130, and a merchant device 150 in communication over a network 170. User 102 may utilize communication device 110 to utilize the various features available for communication device 110, for example, one or more payment processes/features in order to provide a payment to a merchant and/or merchant employee (referred to herein as a “merchant” or “merchants”) associated with merchant device 150. In this regard, merchant device 150 may be utilized to generate a digital invoice for a transaction between user 102 and the merchant/merchant employee for one or more items. The digital invoice may then be published (or broadcast) by merchant device 150 using payment provider server 130 to communication device 110. Payment provider server 130 may provide matching between user 102 and the digital invoice based one or more merchant parameters in merchant/transaction data and one or more user parameters in user information for a plurality of users including user 102. Once the digital invoice is published, user 102 may view the digital invoice on communication device 110 and provide payment to the merchant/merchant employee using the payment processes/features of communication device 110.

Communication device 110, payment provider server 130, and merchant device 150 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 100, and/or accessible over network 170.

Communication device 110 may be implemented as a communication device that may utilize appropriate hardware and software configured for wired and/or wireless communication with payment provider server 130 and/or merchant device 150. For example, in one embodiment, communication device 110 may be implemented as a personal computer (PC), a smart phone, laptop/tablet computer, wristwatch with appropriate computer hardware resources, eyeglasses with appropriate computer hardware (e.g. GOOGLE GLASS®), other type of wearable computing device, implantable communication devices, and/or other types of computing devices capable of transmitting and/or receiving data, such as an IPAD® from APPLE®. Although a communication device is shown, the communication device may be managed or controlled by any suitable processing device. Although only one communication device is shown, a plurality of communication devices may function similarly.

Communication device 110 of FIG. 1 contains a payment application 120, a data application 112, other applications 114, a database 116, and a communication interface 118. Data application 112, payment application 120, and other applications 114 may correspond to executable processes, procedures, and/or applications with associated hardware. In other embodiments, communication device 110 may include additional or different applications having specialized hardware and/or software as required. For example, communication device 110 may include GPS systems, modules, components, or other features used to determine a location of user 102, as well as other specialized components including touch screen interfaces and touch input devices, digital cameras, short range wireless communication antennas and modules (e.g., over Bluetooth Low Energy, Bluetooth, near field communications, WiFi, etc.), and/or other devices.

Payment application 120 may correspond to one or more processes executed by hardware and associated devices of communication device 110 to receive and process/complete transactions with a merchant or merchant employee associated with merchant device 150 using a payment account or other payment instrument for user 102. In this regard, payment application 120 may utilize specialized hardware and/or software utilized by communication device 110 to provide an interface to permit user 102 to enter and select payment options and provide payment for items, for example, to the merchant associated with merchant device 150 using payment provider server 130. Payment application 120 may be implemented as a user interface enabling user 102 to enter payment options for storage by communication device 110, select and provide payment options on checkout/payment of a transaction for one or more items with the merchant corresponding to merchant device 150, and complete the transaction for the item(s) through a payment request for the item(s). In various embodiments, payment application 120 may include a general browser application configured to retrieve, present, and communicate information over the Internet (e.g., utilize resources on the World Wide Web) or a private network. For example, payment application 120 may provide a web browser, which may send and receive information over network 170, including retrieving website information, presenting the website information to user 102, and/or communicating information to the website, including payment information. However, in other embodiments, payment application 120 may include a dedicated application of payment provider server 130 or other entity (e.g., a merchant), which may be configured to assist in processing purchase requests.

In order to engage in the transaction with the merchant associated with merchant device 150, payment application 120 may be required to receives, access, and/or load a digital invoice for the transaction. Payment application 120 may access the digital invoice after receipt by communication device 110 from payment provider server 130 or merchant device 150. In this regard, payment provider server 130 may match the digital invoice to user 102, as discussed herein. Once matched or otherwise correlated to user 102, the digital invoice may be communicated to communication device 110 for display to user 102. Payment application 120 may display the digital invoice having transaction information for the transaction between user 102 and the merchant. Additionally, any other information transmitted with the digital invoice may be displayed through payment application 120 (e.g., a message from payment provider server 130 and/or merchant device 150, merchant information, account balances, available discounts or benefits, etc.). User 102 may view the digital invoice through an output interface of communication device 110 (e.g., a display screen). Additionally, user 102 may edit the digital invoice to change the items and/or amount, and may reject or accept payment for the transaction in the digital invoice. Entry of input to change, accept, and/or reject the digital invoice may be done through an input device of communication device 110, including a mouse, keyboard, and/or touch screen interface.

If user 102 accepts payment for the transaction in the digital invoice, payment application 120 may be utilized to select one or more payment instruments for use during the transaction between user 102 and the merchant associated with merchant device 150. For example, user 102 may wish to complete the transaction with the merchant to purchase the item(s). Payment application 120 may utilize user financial information, such as a credit card, bank account, or other financial account, as a payment instrument when providing payment information for use in the authentication mechanism. Additionally, payment application 120 may utilize a user payment account with payment service provider, such as payment provider server 130, as the payment instrument. After selection of the payment instrument by user 102, user 102 may utilize payment application 120 to transmit a payment request to payment provider server 130 for payment of the transaction. The payment request may be communicated to payment provider server 130, which may provide a corresponding payment to the merchant associated with merchant device 150, as discussed herein. Payment application 120 may be utilized to view the results of the transaction and/or for viewing and storage of a transaction history, such as a receipt.

Data application 112 may correspond to one or more processes executed by hardware and associated specialized hardware of communication device 110 that may be used to collect, store, and communicate user data on user 102, which may include user parameters for user 102. In this regard, payment application 120 may utilize specialized hardware and/or software utilized by communication device 110 to receive, determine, and/or collect one or more user parameters for user 102. The user parameters may correspond to information about user 102, including a location of user 102, personal information for user 102 (e.g., name, address, social security number, etc.), identifiers for one or more accounts of user 102 (e.g., an email, messaging name, social networking contact, phone number, or other identification), other identifiers for objects associated with user 102 (e.g., a vehicle license plate number), and/or images of user 102 or an object associated with user 102. The user parameters may be entered by user 102 to communication device 110 or may be captured using one or more devices or associated hardware of communication device 110 (e.g., a camera, sensor, GPS device, connected biometric device, etc.).

In various embodiments, the user parameters may also include information on biometrics of user 102. Additionally, past information for user 102 may be stored and used as the user parameters, including past locations for user 102 and/or past transactions conducted by user 102 with one or more merchants (including transaction information, such as items, purchase amount, time, location, merchant, etc.). The past transactional information for user 102 may be associated with user interactions for user 102, which may further include search histories, merchant requests/orders, messages, phone calls, and other interactions with users and/or merchants. In other embodiments, payment provider server 130 may also determine, receive, and/or collect the user parameters from one or more other resources, such as other service providers (e.g., messaging, social networking, media sharing, etc.) and/or device (e.g., cameras, sensors, or other devices that may interact with and/or record data on user 102).

In various embodiments, one or more of the discussed hardware and/or software features of payment application 120 and data application 112 may be included in the same application.

In various embodiments, communication device 110 includes other applications 114 as may be desired in particular embodiments to provide features to communication device 110. For example, other applications 114 may include security applications for implementing client-side security features, programmatic client applications for interfacing with appropriate application programming interfaces (APIs) over network 170, or other types of applications. Other applications 114 may also include email, texting, voice and IM applications that allow a user to send and receive emails, calls, texts, and other notifications through network 170. In various embodiments, other applications 114 may include financial applications, such as banking, online payments, money transfer, or other applications. Other applications 114 may also include other location detection applications, which may be used to determine a location for user 102, such as a mapping, compass, and/or GPS application, which can include a specialized GPS receiver that obtains location information for communication device 110 and processes the location information to determine a location of the device. Other applications may include social networking applications and/or merchant applications. Other applications 114 may also be associated with other devices, such as biometric devices and other types of accessible or connected devices. Other applications 114 may include device interfaces and other display applications that may receive input from user 102 and/or output information to user 102. For example, other applications 114 may contain software programs, executable by a processor, including a graphical user interface (GUI) configured to provide an interface to the user.

Communication device 110 may further include database 116 stored to a transitory and/or non-transitory memory of communication device 110, which may store various applications and data and be utilized during execution of various applications of communication device 110. Thus, database 116 may include, for example, identifiers such as operating system registry entries, cookies associated with payment application 120 and/or other applications 114, identifiers associated with hardware of communication device 110, or other appropriate identifiers, such as identifiers used for payment/user/device authentication or identification, which may be communicated as identifying user 102/communication device 110. Database 116 may include location information, such as obtained through the GPS receiver, which may be transmitted to payment provider server 130 and/or merchant device 150, as well as biometrics and other determined or retrieved information. Database 116 may further include additional user parameters.

Communication device 110 includes at least one communication interface 118 adapted to communicate with payment provider server 130 and merchant device 150. In various embodiments, communication interface 118 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices. Communication interface 118 may communicate directly with nearby devices (e.g., merchant device 150) using short range communications, such as Bluetooth Low Energy, LTE Direct, WiFi, radio frequency, infrared, Bluetooth, and near field communications.

Payment provider server 130 may be maintained, for example, by an online payment service provider, which may provide payment services and/or processing for financial transactions on behalf of users. In this regard, payment provider server 130 includes one or more processing applications which may be configured to interact with communication device 110, merchant device 150, and/or another device/server to facilitate receipt of digital invoices and user/merchant data (e.g., user/merchant parameters) and payment for a transaction in the digital invoice, including establishment of payment accounts and payment using the payment accounts. In one example, payment provider server 130 may be provided by PAYPAL®, Inc. of San Jose, Calif., USA. However, in other embodiments, payment provider server 130 may be maintained by or include a credit provider, financial services provider, financial data provider, and/or other service provider, which may provide payment services to user 102. In various embodiments, one or more of the below described processes (e.g., transaction pairing application 140 and/or a subset of the processes of transaction pairing application 140) may also be executed by merchant device 150.

Payment provider server 130 of FIG. 1 includes a transaction pairing application 140, a transaction processing application 132, other applications 134, a database 136, and a network interface component 148. Transaction pairing application 140, transaction processing application 132, and other applications 134 may correspond to executable processes, procedures, and/or applications with associated hardware. In other embodiments, payment provider server 130 may include additional or different applications having specialized hardware and/or software as required.

Transaction pairing application 140 may correspond to one or more processes executed by hardware and associated specialized hardware of payment provider server 130 to receive and/or access a digital invoice for a transaction between user 102 and a merchant corresponding to merchant device 150, pair the digital invoice to user 102 based on user parameters and merchant parameters for user 102 and the merchant, respectively, and cause to be communicated the digital invoice to user 102 for processing and/or payment. In this regard, transaction pairing application 140 may utilize specialized hardware and/or software to first access a received digital invoice by payment provider server 130. As discussed herein, the merchant corresponding to merchant device 150 may generate digital invoice to receive payment for a transaction having one or more items provided by the merchant to user 102. Once the digital invoice is received by payment provider server 130, transaction pairing application 140 may access merchant data for the merchant. The merchant data may be received with the digital invoice. However, in other embodiments, the digital invoice may include an identifier or other information allowing payment provider server 130 to identify the merchant data stored by payment provider server 130 or another service provider. The merchant data may include at least one merchant parameter for the merchant associated with merchant device 150. The merchant parameter(s) may correspond to information associated with one or more past locations or a current location of the merchant and/or a merchant storefront, identifiers used to identify the merchant, past merchant transactions by the merchant with the user, past interactions between the user and the merchant, a merchant category for the merchant, and/or an item category for items sold by the merchant. In other embodiments, transaction data may be used instead, which may correspond to transactional information about the transaction in the digital invoice. Thus, the transaction data may include a transaction time, amount, items in the transaction, identifier for the transaction, transaction location, or other transaction parameter.

After accessing the merchant data, transaction pairing application 140 may then attempt to match the digital invoice to a user based on user information for a plurality of users that is available to transaction pairing application 140. For example, users that utilize payment services and/or a payment application (e.g., payment application 120) associated with payment provider server 130 may have associated user information that transaction pairing application 140 may access. The user information may include user parameters for the users, such as locations of users, past user transactions by the users, the interactions between users and the merchant or other merchants (including associated merchant types or categories), user images for the users, images of objects or items associated with the users, and identifiers of the objects or the items associated with the users.

In order to match user 102 to the digital invoice, transaction pairing application 140 may match or otherwise correlate merchant parameters from the merchant data to the user parameters for the users. Thus, a similar merchant parameter to a user parameter may be used to determine that the user associated with the user parameter may be matched to the digital invoice. For example, a location for user 102 may correspond to a current location for the merchant corresponding to merchant device 150, and thus, user 102 may be linked to the digital invoice based on the shared location. In other embodiments, other similar parameters may be used, including shared interactions, similar images captured by a device, shared past transactions, and/or other shared parameters. In certain embodiments, merchant device 150 may capture an image of user 102 and/or an object/item associated with user 102 (e.g., an image of a car license plate), and may provide the image to transaction pairing application 140 to matching to user 102's parameters.

However, where multiple users may have shared parameters with the merchant's parameters, transaction pairing application 140 may require additional processing to link user 102 to the digital invoice. In various embodiments, the merchant associated with merchant device 150 may provide information communicated by user 102 to the merchant (e.g., in person), such as the last 4 digits of a phone number, an account name or identifier, a part of a street address, or other easily communicated and/or enterable information associated with a user parameter for user 102. The information may be included with the digital invoice, and transaction pairing application 140 may use the information to more confidently or accurately match user 102 to the digital invoice. In other embodiments, transaction pairing application 140 may determine a strength of the correlation between the user parameter(s) and the merchant parameter(s), and may link one or more users to the digital invoice based on the strength of the correlation. Merchant device 150 may receive a list of the matched users (which may be ranked according to the strength of the correlation), so that the merchant may select the correct or intended user. If user 102 does not appear on the list, the merchant may request additional matches.

Once at least one user is matched, transaction pairing application 140 may publish the digital invoice to the matching user(s). Where only user 102 is matched to the digital invoice, user 102 may receive the digital invoice through communication device 110 for acceptance, editing, payment, and/or rejection using payment application 120. However, where a plurality of users are matched to the digital invoice, a highest strength of correlation may be used to publish the digital invoice only to one user or each user may receive the digital invoice through their respective communication device. Thus, user 102 may receive the digital invoice or may access an online account to view the digital invoice. In such embodiments, user 102 may be required to accept the digital invoice. Since no payment has yet been made, the other users may be deterred from accepting the digital invoice, as a payment is still required. User 102 may accept the digital invoice and utilize transaction processing application 132 to provide payment for the digital invoice. In other embodiments, user 102 may edit or reject the digital invoice, where the edits/rejection is communicated back to merchant device 150 for acceptance and/or entered to the transaction in the digital invoice (e.g., where the edits include a tip or gratuity). In various embodiments, transaction pairing application 140 may also provide the digital invoice to communication device 110 in or with a message, which may include one or more communications, merchant/payment provider information, account information, or other provided communication.

Transaction processing application 132 may correspond to one or more processes executed by hardware and associated specialized hardware of payment provider server 130 to receive and/or transmit information from communication device 110 for establishing payment accounts for user 102 and processing one or more transactions. In this regard, transaction processing application 132 may utilize specialized hardware and/or software to establish payment accounts, which may be utilized to send and receive payments and monetary transfers and engage in other financial transactions. User 102 may establish a payment account with transaction processing application 132 by providing personal and/or financial information to payment provider server 130 and selecting an account login, password, and other security information. The payment account may be accessed and/or used through a browser application and/or dedicated payment application executed by communication device 110, such as an application associated with payment application 120. Thus, payment provider server 130 may protect and limit use of the payment account or other payment services offered by payment provider server 130 using authentication required by user 102. In other embodiments, payment provider server 130 may instead receive other financial information for user 102, which may include banking accounts, payment cards, gift balances, and/or benefits/discounts. Such financial instruments may also be used to provide a payment for a transaction.

Transaction processing application 132 may further process a received transaction from merchant device 150 by receiving the transaction having a payment request for a payment for the transaction. The payment request may correspond to a payment token, including an authentication mechanism for the payment instrument and identification of the transaction, and may be encrypted prior to transmission to transaction processing application 132 to prevent unauthorized receipt of a payment instrument. The payment token may include information corresponding to user/merchant identifiers, transaction information and/or other information. Additionally, the payment token may include a payment amount as a payment request and terms of payment for the transaction. The payment token may further include an authentication mechanism used by user 102 to utilize the payment account or other payment instrument of user 102. Once the transaction is received and user 102 is authenticated, transaction processing application 132 may utilize the payment instrument for user 102 to render payment for the transaction if the authentication mechanism matches the required authentication. Payment may be made to merchant device 150 or another user device using the payment instrument and the terms of the payment request, or may be made to an account for a merchant associated with merchant device 150. Additionally, transaction processing application 132 may provide transaction histories, including receipts, to communication device 110 and/or merchant device 150, or may store the transaction histories to the user 102's account and/or the merchant's account.

In various embodiments, payment provider server 130 includes other applications 134 as may be desired in particular embodiments to provide features to payment provider server 134. For example, other applications 134 may include security applications for implementing server-side security features, programmatic client applications for interfacing with appropriate application programming interfaces (APIs) over network 170, or other types of applications. Other applications 134 may contain software programs, executable by a processor, including a graphical user interface (GUI), configured to provide an interface to user 102 when accessing payment provider server 134, where user 102 or other users may interact with the GUI to more easily view and communicate information. In various embodiments where not provided by transaction processing application 132, other applications 134 may include connection and/or communication applications, which may be utilized to communicate information to over network 170.

Additionally, payment provider server 130 includes database 136. As previously discussed, user 102 and/or the merchant corresponding to merchant device 150 may establish one or more payment accounts with payment provider server 130. Payment accounts in database 136 may include user/merchant information, such as name, address, birthdate, payment/funding information, additional user financial information, and/or other desired user data. User 102 and/or the merchant may link to their respective payment accounts through an account, user, merchant, and/or device identifier. Thus, when an identifier is transmitted to payment provider server 130, e.g. from communication device 110 and/or merchant device 150, a payment account belonging to user 102 and/or the merchant may be found. Database 136 may also store information received for a transaction, such as a digital invoice and any other associated information. Database 136 may also store merchant and user parameters, such as data received from communication device 110, merchant device 150, and/or another service provider or data collector.

In various embodiments, payment provider server 130 includes at least one network interface component 148 adapted to communicate communication device 110, merchant device 150, and/or another service provider or data collector over network 170. In various embodiments, network interface component 148 may comprise a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency (RF), and infrared (IR) communication devices.

Merchant device 150 may correspond to a point of sale (POS) and/or check-out machine/device, or may correspond to another type of device for generating a digital invoice for a transaction between user 102 and the merchant associated with merchant device 150. In various embodiments, merchant device 150 may instead correspond to a merchant server. Merchant device 150 may be maintained, for example, by a merchant or seller offering various items, products, and/or services through the physical merchant location. Generally, merchant device 150 may be maintained by anyone or any entity that receives money, which includes charities as well as retailers and restaurants. In this regard, merchant device 150 may include a device having processing applications, which may be configured to interact with communication device 110 and/or payment provider server 130 to facilitate the sale of items using one or more authentication mechanisms for the payment account associated with user 102. In various embodiments, merchant device 150 may also execute one or more of the processes described in reference to payment provider server 130, such as transaction pairing application 140 and/or a subset of processes of transaction pairing application 140.

Merchant device 150 may be implemented using any appropriate hardware and software configured for wired and/or wireless communication with communication device 110, and/or payment provider server 130. For example, in one embodiment, merchant device 150 may be implemented as a single or networked personal computer (PC), a smart phone, laptop computer, wearable computing device, and/or other types of computing devices at a merchant location capable of transmitting and/or receiving data. Although a merchant device is shown, the merchant device may be managed or controlled by any suitable processing device. Although only one merchant device is shown, a plurality of merchant devices may function similarly.

Merchant device 150 of FIG. 1 contains a sales application 152, a merchant information application 160, other applications 154, a database 156, and a communication interface 158. Sales application 152 and other applications 154 may correspond to processes, procedures, and/or applications executable by a hardware processor, for example, a software program. In other embodiments, merchant device 150 may include additional or different applications having specialized hardware and/or software as required.

Sales application 152 may correspond to one or more processes executed by hardware and associated specialized hardware of merchant device 150 that provide checkout and payment processes, which may be configured to generate and process transactions for items. In this regard, sales application 152 may utilize specialized hardware and/or software of merchant device 150 to provide a convenient interface to permit a merchant to enter, view, and/or edit items and/or services for purchase by user 102. For example, sales application 152 may be implemented as an application having a user interface enabling the merchant to enter item information and request payment for a transaction on checkout/payment of one or more items/services. In certain embodiments, sales application 152 may correspond more generally to a web browser configured to view information available over the Internet or access a website corresponding to the merchant and/or payment provider server 130. Sales application 152 may provide item sales through an online marketplace using the website of the merchant and/or through a physical location.

Sales application 152 may generate a digital invoice for the transaction from a merchant input. For example, a merchant may enter items to the transaction and cause a digital invoice to be created that requests payment for the items. In other embodiments, sales application 152 may correspond to an automated sales service which may generate a transaction from received information. Once a payment amount is determined for a transaction for items to be purchased by user 102, sales application 152 may request payment from user 102. Sales application 152 may request payment by transmitting the digital invoice to payment provider server 130 for matching of user 102 to the digital invoice. Once matched, payment provider server 130 and/or sales application 152 may publish the digital invoice to communication device 110 for processing of the transaction, as discussed herein. Sales application 152 may then receive the results of the transaction processing, and complete the transaction with user 102, for example, by providing the user the items for the transaction or declining the transaction where user 102 is not authenticated or the transaction is not authorized (e.g., insufficient funds). Sales application 152 may also receive a transaction history, which may include a receipt.

Merchant information application 160 may correspond to one or more processes executed by hardware and associated specialized hardware of merchant device 150 that determined merchant data for the merchant associated with merchant device 150 and provides the merchant data to payment provider server 130. In this regard, merchant information application 160 may utilize specialized hardware and/or software of merchant device 150 to receive, determine, and/or collect merchant data for the merchant associated with merchant device 150. The merchant data may include merchant parameters, such as location data for a current location of the merchant and/or a merchant storefront, identifiers used to identify the merchant, past merchant transactions by the merchant with the user, past interactions between the user and the merchant, a merchant category for the merchant, and/or an item category for items sold by the merchant. In other embodiments, merchant information application 160 may instead collect transaction information, which may include a transaction time, amount, date, items in the transaction, or other transactional information.

Merchant device 150 includes other applications 154 as may be desired in particular embodiments to provide features to merchant device 150. For example, other applications 154 may include security applications for implementing client-side security features, programmatic client applications for interfacing with appropriate application programming interfaces (APIs) over network 170, or other types of applications. Other applications 154 may also include email, texting, voice and IM applications that allow a user to send and receive emails, calls, texts, and other notifications through network 170. In various embodiments, other applications 154 may include financial applications, such as banking, online payments, money transfer, or other applications associated with payment provider server 130. Other applications 134 may contain software programs, executable by a processor, including a graphical user interface (GUI) configured to provide an interface to the user.

Merchant device 150 may further include database 156 which may include, for example, identifiers such as operating system registry entries, cookies associated with sales application 152 and/or other applications 154, identifiers associated with hardware of merchant device 150, or other appropriate identifiers, such as identifiers used for payment/user/device authentication or identification. Identifiers in database 156 may be used by a payment/credit provider, such as payment provider server 130, to associate merchant device 150 with a particular account maintained by the payment/credit provider. Database 156 may further include a transaction between user 102 and a merchant corresponding to merchant device 150, as well as transaction information and/or merchant data. A digital invoice generated for the transaction may also be stored to database 156.

Merchant device 150 includes at least one communication interface 158 adapted to communicate with communication device 110 and/or payment provider server 130. In various embodiments, communication interface 158 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices.

Telephone device 160 may correspond to a device used for voice communications with another endpoint, such as communication device 110. Telephone device 160 may correspond to a standalone device, which may receive voice data connections, such as a landline telephone, mobile phone, or other telephone type device, including an Internet connected phone configured to use VoIP or other network communication protocol. However, in other embodiments, merchant device 150 and telephone device 160 may be incorporated within the same device so as to provide their respective features in a single device. Telephone device 160 may receive requests to establish voice data connections and establish the voice data connections. During the voice data connections, telephone device 160 may be used to send and receive data through the connection, which may include receipt of user information and/or authentication (e.g., through analog signaling during a phone connection and/or data over a networked connection). Telephone device 160 may be connected to merchant device 150 and configured to provide received information to merchant device 150.

Network 170 may be implemented as a single network or a combination of multiple networks. For example, in various embodiments, network 170 may include the Internet or one or more intranets, landline networks, wireless networks, and/or other appropriate types of networks. Thus, network 170 may correspond to small scale communication networks, such as a private or local area network, or a larger scale network, such as a wide area network or the Internet, accessible by the various components of system 100.

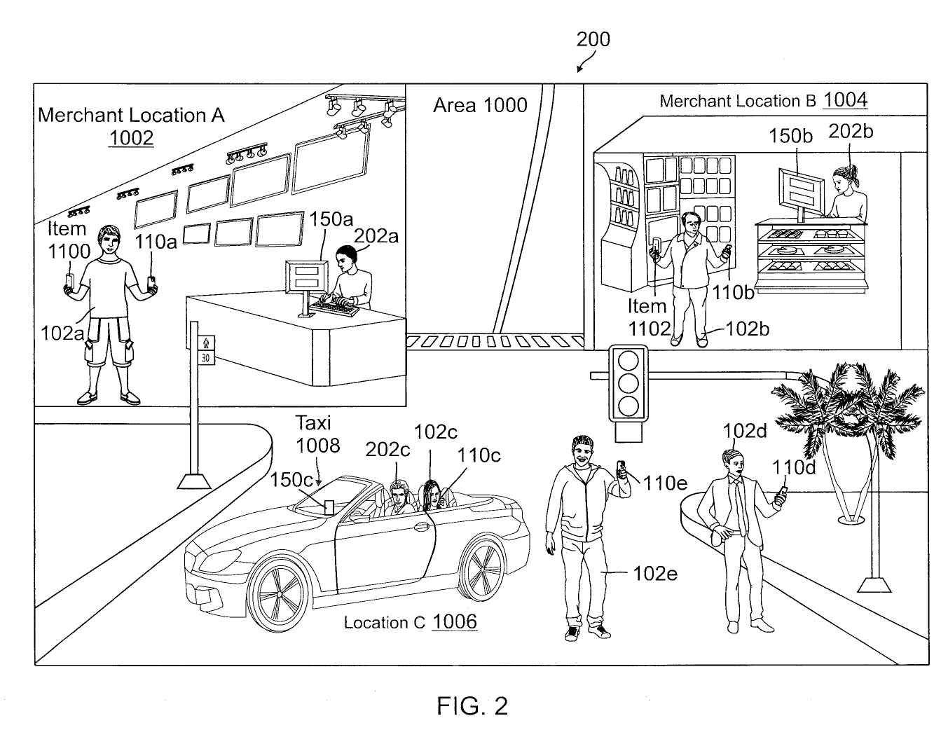

FIG. 2 is an exemplary environment having users and merchants engaged in transactions, where the users may be matched to a pending transaction based on associated data between the user and the merchant, according to an embodiment. Environment 200 includes a user 102a interacting with a communication device 110a, a user 102b interacting with a communication device 110b, a user 102c interacting with a communication device 110c, a user 102d interacting with a communication device 110d, and a user 102e interacting with a communication device 110e all corresponding generally to user 102 interacting with communication device 110, respectively, from environment 100 of FIG. 1. Environment 200 further includes a merchant device 150a, a merchant device 150b, and a merchant device 150c all corresponding generally to merchant device 150 from environment 100 of FIG. 1.

In environment 200, users 102a-e are shown in various locations in an area 1000 where certain ones of users 102a-e are engaged in transactions with merchants. For example, user 102a is shown in a merchant location A 1002 where user 102a may wish to purchase an item 1100 that user 102a has selected at merchant location A 1002. In this regard, a merchant 202a may utilize merchant device 150a to enter information (which does not include an identifier for user 102a) for item 1100 to a transaction and cause merchant device 150a to generate a digital invoice for the transaction. User 102a may then be matched to the digital invoice based on user 102a's location at merchant location A 1002 matching the location for merchant 202a and merchant device 150a. The location for user 102a may be determined using communication device 110a, such as through a GPS device of communication device 110a. Additionally, user 102a may view the digital invoice and provide payment using communication device 110a.

However, user 102b shopping for an item 1102 may not be matched to the digital invoice generated by merchant 202a using merchant device 150a. Instead, user 102b is shown at a merchant location B 1004 where user 102b wishes to purchase item 1102. In similar fashion, a merchant 202b may utilize merchant device 150b to generate a digital invoice for the transaction having item 1102 for purchase by user 102b. User 102b may be matched only to the digital invoice for item 1102 at merchant location B 1104 based on the location of user 102b at merchant location B 1004. Using the location for user 102a and user 102b determined using communication device 110a and communication device 110b, respectively, the proper digital invoice for each user may be determined and matched. Thus, the digital invoice for item 1100 at merchant location A 1002 may not be matched to user 102b as the location for user 102b does not match the location for merchant 202a/merchant device 150a in the digital invoice (i.e., merchant location A 1002). Similarly, the digital invoice for item 1102 at merchant location B 1004 may not be matched to user 102a as the location for user 102a does not match the location for merchant 202b/merchant device 150b in the other digital invoice (i.e., merchant location A 1002).

However, in other embodiments, users may share a similar location or other parameter so that it is more difficult to match the digital invoice to a single user engaged in the transaction in the digital invoice. For example, in area 1000, user 102c may have travelling to location C 1006 in taxi 1008. Thus, merchant 202c may generate an invoice for the taxi ride using merchant device 150c. When attempting to match user 102c to the digital invoice, merchant device 150c and/or a payment provider may receive location information for user 102c from communication device 110c, as well as location information for user 102d and user 102e from communication device 110d and communication device 110e, respectively. As shown in environment 200, user 102d is substantially far from a location of taxi 1008. Thus, user 102d may not be paired to the digital invoice as the location for user 102d determined using communication device 110d does not match the location for merchant 202c/merchant device 150c/taxi 1008 within area 1000.

However, user 102e is shown nearby or within location C 1006. Thus, the location for user 102c and 102e may be similar and user 102e may initially also be matched to the digital invoice for the taxi ride in taxi 1008. Thus, in certain embodiments, user 102c may provide merchant 202c information (e.g., last name, last 4 digits of a phone number, etc.) that allows merchant 202c to enter the information to the digital invoice and more easily match the digital invoice to user 102c. In other embodiments, merchant 202c may also view information for both user 102c and user 102e (e.g., an image, name, etc.), and match the transaction to user 102c based on the displayed information. In further embodiments, the digital invoice may be communicated to both communication device 110c and communication device 110e, where both user 102c and user 102e, respectively, may view the digital invoice. In such embodiments, user 102c may view the digital invoice and accept the digital invoice, removing the digital invoice for acceptance by user 102e.

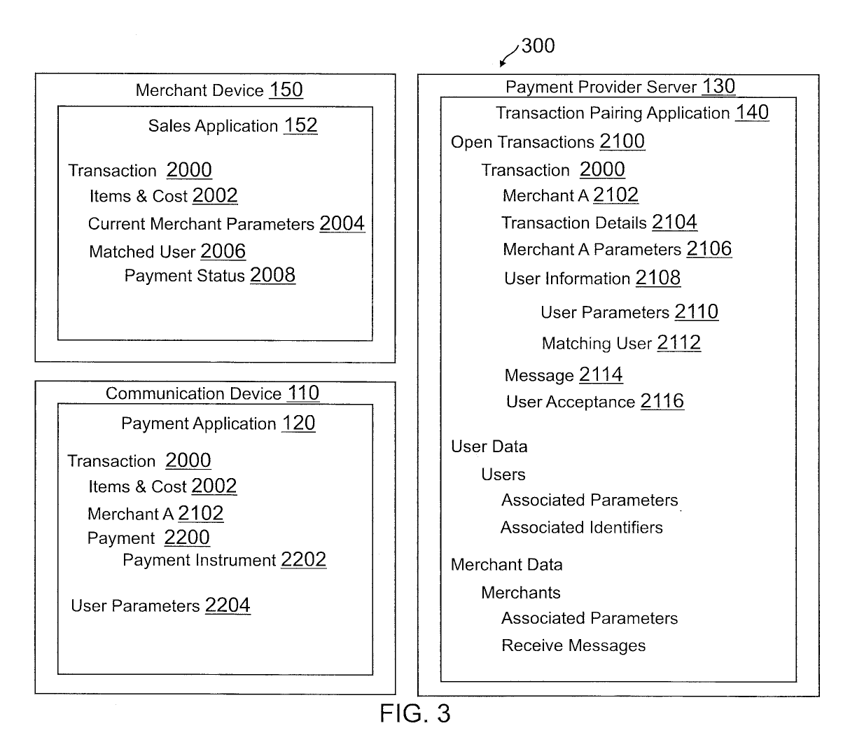

FIG. 3 is an exemplary interaction between a communication device, a payment provider server, and a merchant device for pairing of transactions based on associated data between a user and a merchant, according to an embodiment. Environment 300 of FIG. 3 includes communication device 110, a payment provider server 130, and a merchant device 150 from environment 100 of FIG. 1 executing application and processes discussed in reference to environment 100.

Merchant device 150 executes sales application 152 corresponding generally to the specialized hardware and/or software applications and processes described in reference to FIG. 1. In this regard, sales application 152 may be used to generate a transaction 2000 between a merchant (not shown) for merchant device 150 and a user (not shown) for communication device 110. Thus, transaction 2000 includes items and cost 2002 for transaction 2000. Transaction 2000 may also be associated with current merchant parameters 2004, which may be communicated to payment provider server 130 with a digital invoice for transaction 2000.

Payment provider server 130 executes transaction pairing application 140 corresponding generally to the specialized hardware and/or software applications and processes described in reference to FIG. 1. In this regard, transaction pairing application 140 may include information for open transactions 2100. Open transactions 2100 may include transactions for received digital invoices. Thus, open transactions 2100 include transaction 2000 from merchant device 150. Transaction 2000 may be associated with information used to match the digital invoice for transaction 2000 to the user corresponding to communication device 110. Thus, transaction 2000 may be associated with a merchant A 2102 generating the transaction, and may include transaction details 2104. Transaction pairing application 140 may access merchant A parameters, which may include current merchant parameters 2004. Additionally, transaction pairing application 140 may further access user information 2108 for a plurality of users, which may include user parameters 2110. By correlating merchant A parameters 2106 with user parameters 2110, a matching user 2112 may be determined. Once matched, transaction pairing application 140 provide matched user 2006 to merchant device 150.

Transaction pairing application 140 may access merchant A parameters 2106 and user parameters 2110 from user data 2118 and merchant data 2126. User data 2118 may include information for users 2120. In this regard, user data 2118 includes associated parameters 2122 and associated identifiers 2124. User data 2118 may include information obtained from communication device 110 and/or another service provider or device. For example, user data 2118 may include user parameters 2204 from communication device 110. Similarly, merchant data 2126 may include information for merchants 2128. Thus, merchant data 2126 includes associated parameters 2130 and received messages 2132

Transaction 2000 may also be associated with a message 2114, which may be transmitted to communication device 110 with the digital invoice for transaction 2000. Using matching user 2112, and message 2114 where required, a digital invoice for transaction 2000 may be communicated to communication device 110. Communication device 110 executes payment application 120 corresponding generally to the specialized hardware and/or software applications and processes described in reference to FIG. 1. In this regard, payment application 120 may be used to view a received digital invoice, which may include information for transaction 2000. Thus, payment application 120 displays items and cost 2002 for transaction 2000. Additionally, payment application 120 may further include information for merchant A 2102. The user associated with communication device 110 may accept the digital invoice, which may provide a user acceptance 2116 to transaction pairing application 140. Additionally, the user may provide a payment 2200 for transaction 2000 using payment instrument 2202. Payment provider server 130 may process a payment using payment instrument 2202, and may provide notification of payment status 2008 to merchant device 150.

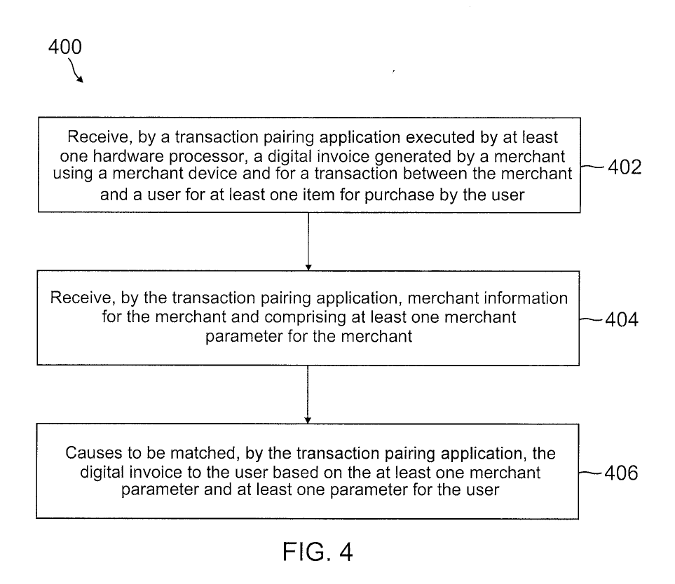

FIG. 4 is a flowchart of an exemplary process for pairing of transaction partners using associated data and identifiers, according to an embodiment. Note that one or more steps, processes, and methods described herein may be omitted, performed in a different sequence, or combined as desired or appropriate.

At step 402, a digital invoice generated by a merchant using a merchant device and for a transaction between the merchant and a user for at least one item for purchase by the user is received, by a transaction pairing application executed by at least one hardware processor. In various embodiments, a message to user for viewing through the communication device and comprising the digital invoice may also be received, and packaged with the digital invoice for presentation to the user through an application of the communication device. The message may comprise a first communication from the merchant to the user, a second communication from a payment provider associated with the transaction pairing application to the user, merchant information identifying the merchant, and/or transaction information for the transaction.

Merchant information for the merchant and comprising at least one merchant parameter for the merchant is received, by the transaction pairing application, at step 404. In various embodiments, the at least one merchant parameter may comprise at least one of a merchant location for the merchant, a current location associated with the merchant or merchant employee causing the digital invoice to be created using the merchant device, a merchant identifier for the merchant, past merchant transactions by the merchant with the user, past interactions between the user and the merchant, a merchant category for the merchant, and an item category for items sold by the merchant.

User information for the plurality of users including the user may also be accessed. The user information may include at least one user parameter for the user, such as a location for the user, past user transactions by the user, the interactions between the user and the merchant, a user image for the user, an image of an object or item associated with the user, and/or an identifier of the object or the item associated with the user. The transaction pairing application may match the user to the digital invoice by determining that the at least one merchant parameter is associated with the at least one user parameter based on a correlation between the at least one merchant parameter and the at least one user parameter. In various embodiments, the correlation may further comprise a certainty level based on a strength of match between the at least one merchant parameter and the at least one user parameter. The certainty level may be based on at least one shared location, previous interactions between the user and the merchant, previous transactions between the user and the merchant, a social networking post by the user, a message by the user, shared media by the user.

The transaction pairing application may further receive an image taken by the merchant using the merchant device or a camera associated with the merchant, wherein the correlation matches the image to at least one of the user image of the user, the image of the object or the item associated with the user, and the identifier of the object or the item associated with the user. In other embodiments, the transaction pairing application may further receive user information for the user provided by the user to the merchant device and included with the digital invoice, wherein the user information matches the at least one user parameter, and wherein the user information and the at least one user parameter comprises one of a user name, a user account name, a user nickname for an account of the user, a user phone number, a user address, a user email address, a user messenger name, and a user code word identifying the user.

At step 406, the digital invoice to the user is matched, by the transaction pairing application, based on the at least one merchant parameter and at least one parameter for the user. After matching, the digital invoice may be communicated to the user for processing. The user may accept the digital invoice and may communicate the acceptance of the digital invoice to the payment provider for processing. The payment provider may then process the payment request for the digital invoice by providing a payment for the transaction in the digital invoice to the user.

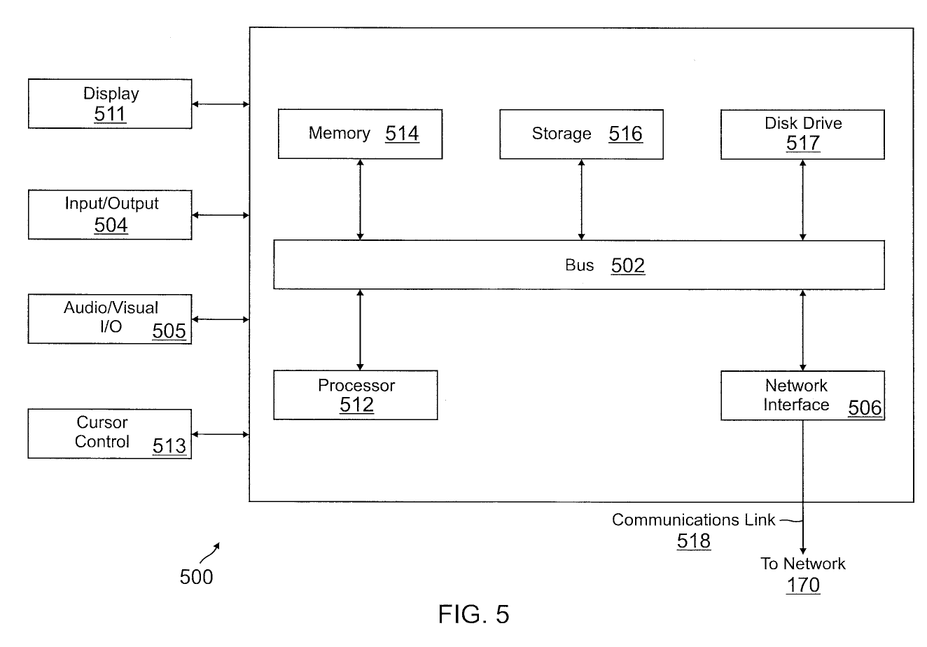

FIG. 5 is a block diagram of a computer system suitable for implementing one or more components in FIG. 1, according to an embodiment. In various embodiments, the communication device may comprise a personal computing device (e.g., smart phone, a computing tablet, a personal computer, laptop, a wearable computing device such as glasses or a watch, Bluetooth device, key FOB, badge, etc.) capable of communicating with the network. The service provider may utilize a network computing device (e.g., a network server) capable of communicating with the network. It should be appreciated that each of the devices utilized by users and service providers may be implemented as computer system 500 in a manner as follows.

Computer system 500 includes a bus 502 or other communication mechanism for communicating information data, signals, and information between various components of computer system 500. Components include an input/output (I/O) component 504 that processes a user action, such as selecting keys from a keypad/keyboard, selecting one or more buttons, image, or links, and/or moving one or more images, etc., and sends a corresponding signal to bus 502. I/O component 504 may also include an output component, such as a display 511 and a cursor control 513 (such as a keyboard, keypad, mouse, etc.). An optional audio input/output component 505 may also be included to allow a user to use voice for inputting information by converting audio signals. Audio I/O component 505 may allow the user to hear audio. A transceiver or network interface 506 transmits and receives signals between computer system 500 and other devices, such as another communication device, service device, or a service provider server via network 170. In one embodiment, the transmission is wireless, although other transmission mediums and methods may also be suitable. One or more processors 512, which can be a micro-controller, digital signal processor (DSP), or other processing component, processes these various signals, such as for display on computer system 500 or transmission to other devices via a communication link 518. Processor(s) 512 may also control transmission of information, such as cookies or IP addresses, to other devices.

Components of computer system 500 also include a system memory component 514 (e.g., RAM), a static storage component 516 (e.g., ROM), and/or a disk drive 517. Computer system 500 performs specific operations by processor(s) 512 and other components by executing one or more sequences of instructions contained in system memory component 514. Logic may be encoded in a computer readable medium, which may refer to any medium that participates in providing instructions to processor(s) 512 for execution. Such a medium may take many forms, including but not limited to, non-volatile media, volatile media, and transmission media. In various embodiments, non-volatile media includes optical or magnetic disks, volatile media includes dynamic memory, such as system memory component 514, and transmission media includes coaxial cables, copper wire, and fiber optics, including wires that comprise bus 502. In one embodiment, the logic is encoded in non-transitory computer readable medium. In one example, transmission media may take the form of acoustic or light waves, such as those generated during radio wave, optical, and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EEPROM, FLASH-EEPROM, any other memory chip or cartridge, or any other medium from which a computer is adapted to read.

In various embodiments of the present disclosure, execution of instruction sequences to practice the present disclosure may be performed by computer system 500. In various other embodiments of the present disclosure, a plurality of computer systems 500 coupled by communication link 518 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. A system for pairing devices using matching parameter data comprising:
a transaction pairing application executed by at least one hardware processor that accesses a digital invoice that excludes an identifier for a user generated by a merchant device for a transaction between a merchant associated with the merchant device and the user, accesses merchant data for the merchant and comprising at least one merchant parameter for the merchant, accesses user information for a plurality of users including the user, wherein the user information comprises at least one user parameter for the user, matches the user to the digital invoice based on the at least one merchant parameter and the at least one user parameter, and accesses an identifier used to communicate with a communication device for the user;
a database stored in a non-transitory memory that stores the digital invoice, the merchant data, the user information, and the identifier; and
a network interface component that receives the digital invoice from the merchant device and communicates the digital invoice to the user using the identifier.

2. The system of claim 1, wherein the transaction pairing application further generates a message to the communication device and comprising the digital invoice, wherein the network interface component communicate the message to the user for display to the user through a payment interface of a mobile payment application executing on the communication device.

3. The system of claim 2, wherein the message further comprises at least one of a first communication from the merchant to the user, a second communication from a payment provider associated with the transaction pairing application to the user, merchant information identifying the merchant, and transaction information for the transaction.

4. The system of claim 1, wherein the at least one merchant parameter comprises at least one of a merchant location for the merchant, a current location associated with the merchant or merchant employee causing the digital invoice to be created using the merchant device, a merchant identifier for the merchant, past merchant transactions by the merchant with the user, past interactions between the user and the merchant, a merchant category for the merchant, and an item category for items sold by the merchant.

5. The system of claim 4, wherein the at least one user parameter for the user comprises at least one of a location for the user, past user transactions by the user, the interactions between the user and the merchant, a user image for the user, an image of an object or item associated with the user, user voice data and an identifier of the object or the item associated with the user.

6. The system of claim 1, wherein the transaction pairing application matches the user to the digital invoice by determining that the at least one merchant parameter is associated with the at least one user parameter based on a correlation between the at least one merchant parameter and the at least one user parameter.

7. The system of claim 6, wherein the correlation further comprises a certainty level based on a strength of match between the at least one merchant parameter and the at least one user parameter.

8. The system of claim 7, wherein the certainty level is based on at least one shared location, previous interactions between the user and the merchant, previous transactions between the user and the merchant, a social networking post by the user, a message by the user, shared media by the user.

9. The system of claim 6, wherein the transaction pairing application further receives an image taken by the merchant using the merchant device or a camera associated with the merchant, and wherein the correlation matches the image to at least one of the user image of the user, the image of the object or the item associated with the user, and the identifier of the object or the item associated with the user.

10. The system of claim 6, wherein the transaction pairing application further receives user information for the user provided by the user to the merchant device and included with the digital invoice, wherein the user information matches the at least one user parameter, and wherein the user information and the at least one user parameter comprises one of a user name, a user account name, a user nickname for an account of the user, a user phone number, a user address, a user email address, a user messenger name, and a user code word identifying the user.

11. The system of claim 1, further comprising:
a transaction processing application executed by at least one hardware processor that receives acceptance of the digital invoice from the user, wherein the acceptance further comprises a payment request to the merchant using a payment instrument of the user, and processes the payment request to provide a payment to the merchant using the payment instrument.

12. The system of claim 11, wherein the payment instrument comprises a payment account with a payment provider associated with the transaction processing application, and wherein the payment provided deducts an amount for the payment from the payment account and provides the amount to the merchant using a merchant account.

13. The system of claim 1, wherein the digital invoice further comprises a merchant identifier used to access the merchant data.

14. The system of claim 1, wherein the identifier for the user is associated with one of a mobile phone number, a mobile phone device, a messaging account, an email account, a payment account, and a mobile application.

15. A method comprising:
receiving, by a transaction pairing application that comprises at least one hardware process, a digital invoice from a merchant device for a merchant, wherein the digital invoice is for a transaction between the merchant and a user for at least one item purchasable by the user and excludes any user identifiers;
accessing, by the transaction pairing application, merchant data for the merchant, wherein the merchant information comprises at least one merchant parameter associated with the merchant;
accessing, by the transaction pairing application, user data for a plurality of users including the user, wherein the user information comprises at least one user parameter for the user; and
determining, by the transaction pairing application, that the user is associated with the digital invoice for the transaction based on the at least one merchant parameter and the at least one user parameter.

16. The method of claim 15, wherein the determining that the user is matched to the merchant for the transaction comprises publishing the digital invoice for acceptance by one of a subset of users having user parameters matching the at least one merchant parameter, wherein the subset of users comprises the user and wherein the user accepts the digital invoice published to the subset of users.

17. The method of claim 16, wherein the publishing the digital invoice comprises one of posting the digital invoice to an online portal for acceptance by the subset of users and communicating the digital invoice to each of the subset of users.

18. The method of claim 15, wherein the accessing the merchant data comprising receiving the merchant data with the transaction from the merchant device.

19. A non-transitory computer-readable medium comprising executable applications which, in response to execution by a computer system, cause the computer system to perform a method comprising:
receiving, by a transaction pairing application executed by at least one hardware processor, a digital invoice that excludes any user identifiers communicated by a merchant device and for a transaction between a merchant associated with the merchant device and a user for at least one item for purchase by the user;
receiving, by the transaction pairing application, merchant information for the merchant and comprising at least one merchant parameter for the merchant; and
causing to be matched, the digital invoice to the user based on the at least one merchant parameter and at least one parameter for the user.

20. The non-transitory computer-readable medium of claim 19, wherein the transaction comprises a payment request for the transaction between the user and the merchant, and wherein the method further comprises:
receiving, by the transaction processing application executed by at least one hardware processor, acceptance of the digital invoice by the user, wherein the acceptance includes a payment request to the merchant by the user using a payment instrument associated with the user; and
processing, by the transaction processing application, the payment request to provide a payment to the merchant using the payment instrument.
